(19) United States
(12) Patent Application Publication
(10) Pub. No.: US 2017/0097219 A1
(43) Pub. Date: Apr. 6, 2017

(54) Adjustable ruler and measuring device

(71) Applicants: Karen Kay Buckley, Carlisle, PA (US); Joseph David Buckley, Carlisle, PA (US)

(72) Inventors: Karen Kay Buckley, Carlisle, PA (US); Joseph David Buckley, Carlisle, PA (US)

(21) Appl. No.: 14/998,031

(22) Filed: May 5, 2015

(51) Int. Cl. G01B 3/08; D05B 91/00

(52) U.S. Cl. CPC G01B 3/08; D05B 91/00

(57) ABSTRACT

The present invention provides an adjustable measuring device comprising a starting piece, an end cap piece and at least three straight pieces. Further, when the starting piece is coupled and capped with the end cap piece or coupled with one or more of the straight piece of the three straight pieces and capped with the end cap piece, a transportable, perfectly flat square or rectangular ruler measuring at least 3 inches in width and one of 6 inches, 12 inches, 18 inches, 24 inches and continuing in 6 inch increments, in length, is created, which can be used for marking, trimming or cutting.

### BACKGROUND OF THE INVENTION

1. Field of the Invention

The present invention is directed generally to marking tools and measuring devices used in the field of quilting, needlework, sewing and fabric art, specifically an adjustable measuring device.

2. Description of the Prior Art

Quilters, fabric artists, appliquers, sewers, and needlework artists design and create three dimensional objects of art. One of the most useful tools for measuring and cutting is a square or rectangular measuring device. Quilters and sewers also take numerous classes and workshops at quilt shows, quilt guild meetings and quilting and sewing shops. Quilters and sewers are required to transport his or her measuring devices with them to these events, workshops or meetings. There are many varying sizes of quilting and sewing measuring devices and markers of varying widths and lengths, but generally the same thickness and made of the same transparent material. In addition to varying widths (1 inch, 2 inch, 3 inch, 4 inch, 6 inch, 12 inch, etc.) and varying lengths (6 inch, 12 inch, 18 inch, 24 inch, etc.) and lengths, these measuring devices have a variety of markings but generally on the quarter inch in both the vertical and horizontal. While working on the companion invention at application Ser. No. 14/998,030, the inventors placed a number of the straight pieces and capped both with corner pieces creating a straight edge measuring device over 48 inches long. The idea was what if an adjustable measuring device constructed using similar interlocking coupling fingers with square ends, could be created. This would enable the quilter or sewer to have an easily transportable measuring device for measuring and cutting which could adjust from 6 inches upward at 6 inch increments. The three inch width and the six inch width were chosen as the most used widths of rules used by quilters and sewers. The result was the adjustable measuring device which couples and separates easily and when coupled creates a measuring device with the strength and utilization of conventional measuring devices. Rather than transport numerous measuring devices, one need only transport one or two adjustable measuring devices.

Therefore as for quilters, sewers, needlepoint artists and fabric artists, there is a need for an adjustable measuring tool.

### SUMMARY OF THE INVENTION

The present invention consists of a set of five (5) or more pieces constructed of approximately 1/10 inch thick PETG (Polyethylene terephthalate glycol-modified), a clear amorphous thermoplastic; Piece 1, a straight edged beginning section, 5.48 inches in length having a uniform width with all other pieces and extending interlocking ends when joined with the cap piece or one or more of the other pieces and the cap piece create various sizes of squares and/or rectangles for marking, trimming and cutting fabric; Piece 2, a I inch cap piece having a uniform width with all other pieces and an interlocking beginning and straight edge end when joined with Piece 1 creates a six inch long measuring device, and when joined with Piece one and other pieces then capped with piece 2 would create rectangles in lengths of 12, 18, 24, 30, 36 and any multiple of 6; Piece 3, Piece 4, Piece 5 and any desired additional piece, is a joining piece 6.48 inches in length having a uniform width with all other pieces with accepting interlocking beginnings and extending interlocking ends which when joined with the beginning and cap piece or one or more of the other pieces create various sizes of rectangles, in successive six inch increments for marking, trimming and cutting fabric.

The tool can be of differing widths and have differing markings, but at a minimum would on both edges have inch markings with bold Roman Numerals designating the 1, 2, 3, 4, 5, 6, etc., except that the cap piece would have no designated Roman Numeral marking, have hash marks of descending sizes for the ½ inch, the ¼ inch and the ⅛ inch marking

The tool will allow the user to have an easily transportable tool which may be built the desired size of Measuring device from 6 inches to 24 inches or more in six inch intervals for marking, trimming and cutting fabric.

### BRIEF DESCRIPTION OF THE DRAWINGS

FIG. 1A illustrates a plan view of a starting piece of adjustable measuring device showing equally spaced interlocking coupling fingers, in accordance with an embodiment;

FIG. 1B illustrates and end view of the starting piece of FIG. 1A, in accordance with an embodiment;

FIG. 1C illustrates the starting piece of FIG. 1A with markings, in accordance with an embodiment;

FIG. 2A illustrates a plan view of an end cap piece of the adjustable measuring device, in accordance with an embodiment;

FIG. 2B illustrates an edge view of the end cap piece of FIG. 2A, in accordance with an embodiment;

FIG. 2C illustrates the end cap piece of FIG. 2A with markings, in accordance with an embodiment;

FIG. 3A illustrates three straight pieces in accordance with an embodiment;

FIG. 3B illustrates a plan view of a straight piece of the three straight pieces of FIG. 3A, in accordance with an embodiment;

FIG. 3C illustrates an edge view of the straight piece of FIG. 3B, in accordance with an embodiment;

FIG. 4 illustrates the adjustable measuring device in accordance with an exemplary embodiment;

FIG. 5A illustrates adjustable measuring devices of six inch and three inch widths adjusted to 6 inch in length, in accordance with an embodiment;

FIG. 5B illustrates adjustable measuring devices of six inch and three inch widths adjusted to 12 inch in length, in accordance with an embodiment;

FIG. 5C illustrates adjustable measuring devices of six inch and three inch widths adjusted to 18 inch in length, in accordance with an embodiment; and

FIG. 6 illustrates adjustable measuring devices of six inch and three inch widths adjusted to 24 inch in length, in accordance with an embodiment.

### DESCRIPTION OF THE PREFERRED EMBODIMENT

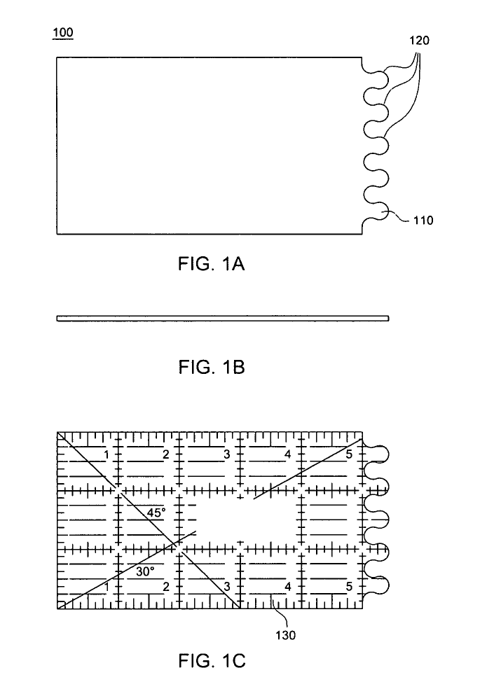

FIG. 1A illustrates a plan view of a starting piece 100 of adjustable measuring device showing equally spaced interlocking coupling fingers 120, in accordance with an embodiment. FIG. 1B illustrates and end view of the starting piece 100 of FIG. 1A, in accordance with an embodiment. FIG. 1C illustrates the starting piece 100 of FIG. 1A with markings 130, in accordance with an embodiment. The starting piece 100, having between 0.05 to 0.15 inch in thickness, is made of a transparent material, having a squared beginning edge, being at least 3 inches in width, with two equal side of length between 5 and 6 inches, and having an open end 110 of five equally spaced, extended, interlockable coupling fingers 120 on the open end 110.

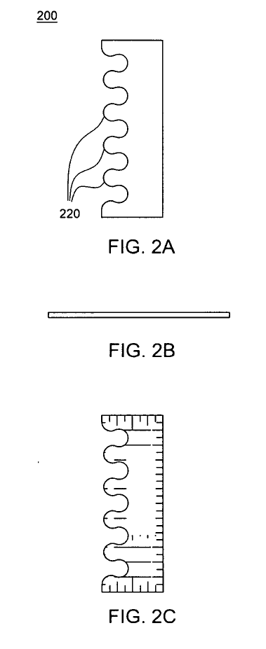

FIG. 2A illustrates a plan view of an end cap piece 200 of the adjustable measuring device, in accordance with an embodiment. FIG. 2B illustrates an edge view of the end cap piece 200 of FIG. 2A, in accordance with an embodiment. FIG. 2C illustrates the end cap piece 200 of FIG. 2A with markings 230, in accordance with an embodiment. The end cap piece 200, having between 0.05 to 0.15 inch in thickness, is made of the transparent material, having a squared ending edge, being at least 3 inches in width, with two equal sides of length between 0.5 and 1.5 inch, and having a minimum of five equally spaced interior couplings 220 to accept and join the interlockable coupling fingers of other pieces.

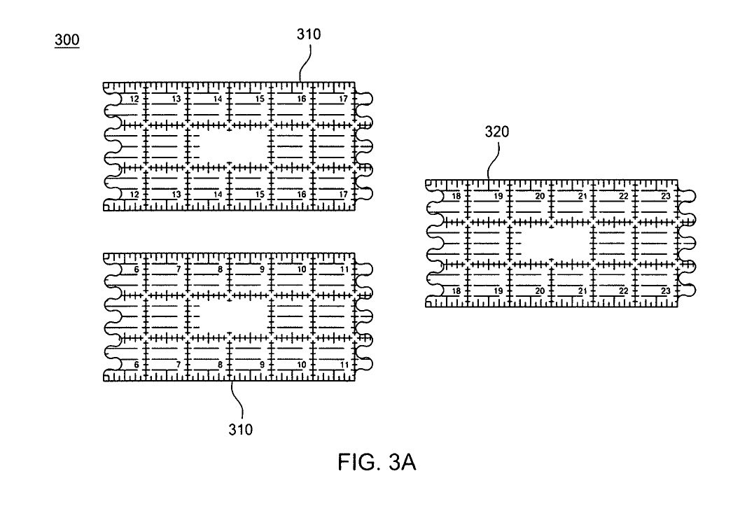

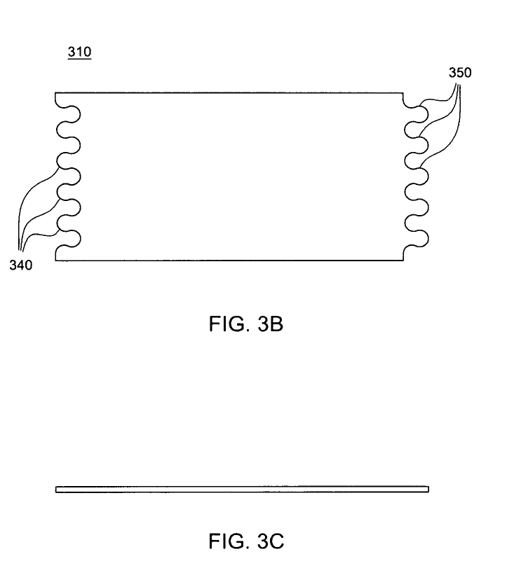

FIG. 3A illustrates three straight pieces 310, 320 and 330, in accordance with an embodiment. FIG. 3B illustrates a plan view of the straight piece 310 of the three straight pieces 310, 320 and 330, in accordance with an embodiment. FIG. 3C illustrates an edge view of the straight piece 310 of FIG. 3B, in accordance with an embodiment. Each of the three straight pieces 310, 320 and 330 is between 0.05 to 0.15 inch in thickness, made of the transparent material, being at least 3 inches in width, each straight piece with two equal sides of length between 6 and 7 inches, and having a minimum of five equally spaced interior couplings 340 on one end, to accept and join the interlockable coupling fingers of other pieces and having a minimum of five equally spaced, extended, interlockable coupling fingers 350 on another end. Further, when the starting piece 100 is coupled and capped with the end cap piece 200 or coupled with one or more of the straight piece of the three straight pieces 310, 320 and 330 and capped with the end cap piece 200, a transportable, perfectly flat square or rectangular measuring device measuring at least 3 inches in width and one of 6 inches, 12 inches, 18 inches, 24 inches and continuing in 6 inch increments, in length, is created, which can be used for marking, trimming or cutting.

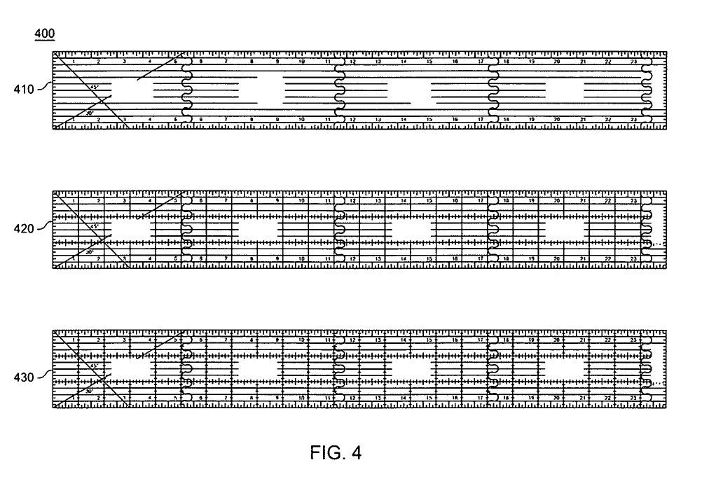

FIG. 4 illustrates the adjustable measuring devices 410, 420 and 430 in accordance with an exemplary embodiment. In accordance with an embodiment, each one of the starting piece 100, the end cap piece 200 and the at least three straight pieces 310, 320 and 330, is six inches in width. In accordance with an embodiment, each one of the starting piece 100, the end cap piece 200 and the at least three straight pieces 310, 320 and 330 has etched or marked along its outside edge every ⅛ inch with the inch marking being longest having a length equal to that of the respective length or width of the piece, the ½ inch marking having a length of ¼ inch, the ¼ inch marking having a length equal to one half the ½ inch marking and the ⅛ inch marking having a length equal to one half the length of the ¼ inch marking.

In accordance with an embodiment, each one of the starting piece 100, the end cap piece 200 and the at least three straight pieces 310, 320 and 330 along the inch lines running the length and width of the pieces, further being etched or marked along the inch line every ⅛^{th} of an inch with the inch marking being the exact center of the ⅛^{th} inch markings, the ½ inch marking having a length of ¼ inch, the ¼ inch marking having a length equal to one half the ½ inch marking and the ⅛ inch marking having a length equal to one half the length of the ¼ inch marking.

In accordance with an embodiment, the adjustable measuring device further comprises indicia including a series of partial parallel markings represented by unconnected lines ⅝ inch in length and running parallel at ¼ inch intervals from each edge of the adjustable measuring device. In accordance with an embodiment, the indicia includes on markings of the starting piece and diagonal angle lines for 45 degrees, 30 degrees and 60 degrees. In accordance with an embodiment, the indicia includes on all pieces roman numerals along the two sides running parallel to each other and at 90 degrees to the beginning edge, beginning with the number 1 before the one inch mark on each edge and sequentially adding the next higher whole roman numeral before the next inch mark line on each of the starting piece 100 and the at least three straight pieces 310, 320 and 330. In accordance with an embodiment, the marked roman numerals are incased in a transparent square.

The quarter inch mark is a very important marking for sewers and quilters thus the numerous parallel lines on the measuring device together with angle markings help the user to have proper placement prior to marking or cutting. The thickness of the material and the interlocking coupling fingers assure the user the edges will be smooth and stable facilitating the easy use of rotary cutters.

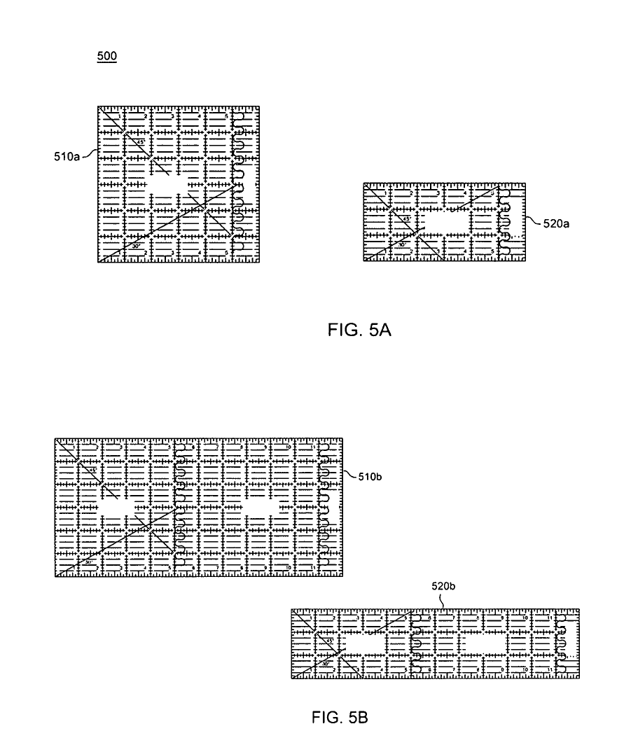

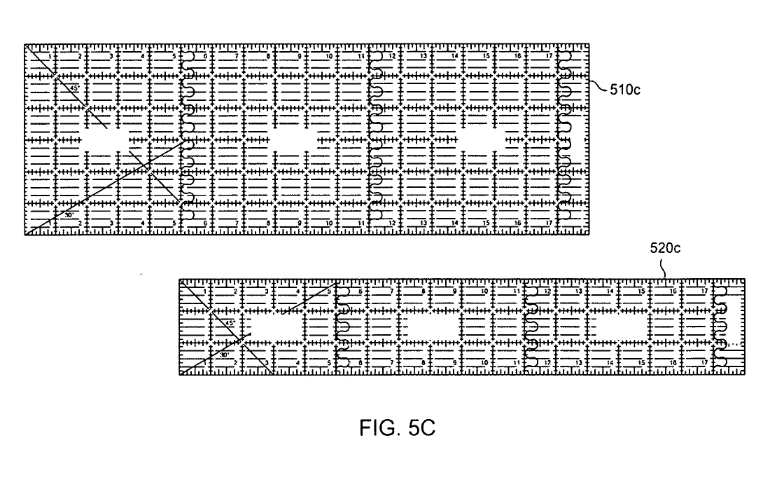

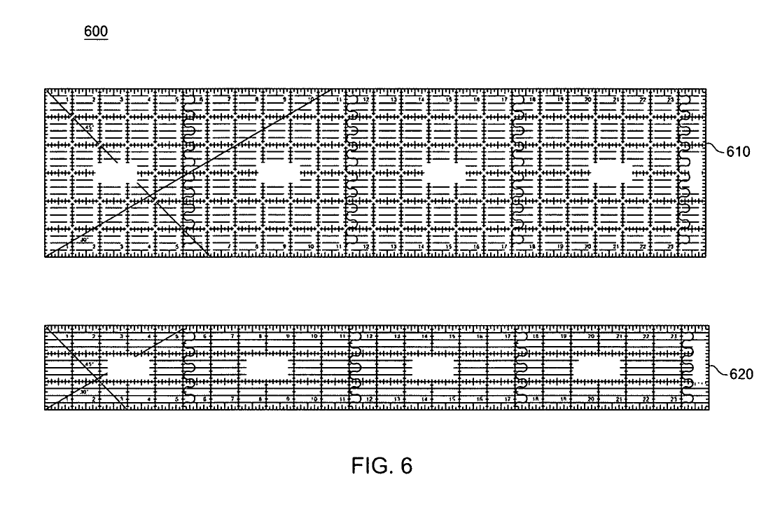

FIG. 5A illustrates adjustable measuring devices of six inch 510a and three inch widths 520a adjusted to 6 inch in length, in accordance with an embodiment. FIG. 5B illustrates adjustable measuring devices of six inch 520a and three inch 520b widths adjusted to 12 inch in length, in accordance with an embodiment. FIG. 5C illustrates adjustable measuring devices of six inch 510c and three inch 520c widths adjusted to 18 inch in length, in accordance with an embodiment. Also, FIG. 6 illustrates adjustable measuring devices of six inch 610 and three inch 620 widths adjusted to 24 inch in length, in accordance with an embodiment

Each one of the starting piece 100, the end cap piece 200 and the at least three straight pieces 310, 320 and 330 is made of between 0.05 to 0.15 inch thickness of PETG (Polyethylene terephthalate glycol-modified), a clear amorphous thermoplastic, or any similar thermoplastic, and has interlocking coupling fingers or receiving couplings. The end cap piece 200 does not have a specific measuring numeral, but the end length is readily assumable and easily ascertained.

The pieces snap firmly into place by lining the pieces and pressing together. They are easily separated by holding the pieces at or near the coupling and rotating one piece clockwise and the other piece counter-clockwise. The adjustable measuring device is easily stored and transportable and alleviates the need for owning or transporting multiple measuring devices. Further, a storage bag may also be provided.

1. An adjustable measuring device comprising:
a starting piece, between 0.05 to 0.15 inch in thickness, made of a transparent material, having a squared beginning edge, being at least 3 inches in width, with two equal side of length between 5 and 6 inches, and having an open end of five equally spaced, extended, interlockable coupling fingers on the open end;
an end cap piece, between 0.05 to 0.15 inch in thickness, made of the transparent material, having a squared ending edge, being at least 3 inches in width, with two equal sides of length between 0.5 and 1.5 inch, and having a minimum of five equally spaced interior couplings to accept and join the interlockable coupling fingers of other pieces;
at least three straight pieces, each between 0.05 to 0.15 inch in thickness, made of the transparent material, being at least 3 inches in width, each straight piece with two equal sides of length between 6 and 7 inches, and having a minimum of five equally spaced interior couplings on one end, to accept and join the interlockable coupling fingers of other pieces and having a minimum of five equally spaced, extended, interlockable coupling fingers on another end;
wherein when the starting piece is coupled and capped with the end cap piece or coupled with one or more of the straight piece of the three straight pieces and capped with the end cap piece, a transportable, perfectly flat square or rectangular ruler measuring at least 3 inches in width and one of 6 inches, 12 inches, 18 inches, 24 inches and continuing in 6 inch increments, in length, is created, which can be used for marking, trimming or cutting.

2. An adjustable measuring device as claimed in claim 1 wherein each one of the starting piece, the end cap piece and the at least three straight pieces is six inches in width.

3. An adjustable measuring device as claimed in claim 1 or 2 wherein each one of the starting piece, the end cap piece and the at least three straight pieces has etched or marked along its outside edge every ⅛ inch with the inch marking being longest having a length equal to that of the respective length or width of the piece, the ½ inch marking having a length of ¼ inch, the ¼ inch marking having a length equal to one half the ½ inch marking and the ⅛ inch marking having a length equal to one half the length of the ¼ inch marking.

4. An adjustable measuring device as claimed in claim 1, 2 or 3 wherein each one of the starting piece, the end cap piece and the at least three straight pieces along the inch lines running the length and width of the pieces, further being etched or marked along the inch line every ⅛^{th} of an inch with the inch marking being the exact center of the ⅛^{th} inch markings, the ½ inch marking having a length of ¼ inch, the ¼ inch marking having a length equal to one half the ½ inch marking and the ⅛ inch marking having a length equal to one half the length of the ¼ inch marking.

5. An adjustable measuring device as claimed in claim 1, 2, 3 or 4, further comprising indicia including a series of partial parallel markings represented by unconnected lines ⅝ inch in length and running parallel at ¼ inch intervals from each edge of the adjustable measuring device.

6. An adjustable measuring device as claimed in claim 5, wherein the indicia includes on markings of the starting piece and diagonal angle lines for 45 degrees, 30 degrees and 60 degrees.

7. An adjustable measuring device as claimed in claim 5 or 6 wherein the indicia includes on all pieces roman numerals along the two sides running parallel to each other and at 90 degrees to the beginning edge, beginning with the number 1 before the one inch mark on each edge and sequentially adding the next higher whole roman numeral before the next inch mark line on each of the starting piece and the at least three straight pieces.

8. An adjustable measuring device as claimed in claim 7, wherein the marked roman numerals are incased in a transparent square.
